(19) United States
(12) Patent Application Publication
(10) Pub. No.: US 2025/0149323 A1
(43) Pub. Date: May 8, 2025

(54) MASS SPECTROMETRY DEVICE

(71) Applicant: SHIMADZU CORPORATION, Kyoto-shi (JP)

(72) Inventors: Kohei HOSOO, Kyoto-shi (JP); Tomoya KUDO, Kyoto-shi (JP)

(21) Appl. No.: 18/833,824

(22) PCT Filed: Feb. 25, 2022
(86) PCT No.: PCT/JP2022/007851

§ 371 Date: Jul. 26, 2024

(51) Int. Cl. H01J 49/14; G01N 30/02; G01N 30/72; H01J 49/24

(52) U.S. Cl. CPC H01J 49/14; G01N 30/7233; H01J 49/24; G01N 2030/027

(57) ABSTRACT

A lock mechanism (300) includes a lever (301) and an engaging portion (302). The lever (301) is provided in a main body (100) or an ion source (200), and is rotatable between a locked state in which the ion source (200) is maintained in a closed state with respect to the main body (100) and an unlocked state in which the ion source (200) is openable with respect to the main body (100). The engaging portion (302) includes a first engaging member (321) and a second engaging member (322) at least one of which is rotatably provided, and the first engaging member (321) and the second engaging member (322) are engaged with each other in the locked state. At least one of the first engaging member (321) and the second engaging member (322) rotates while being in contact with each other as the lever (301) rotates from the unlocked state to the locked state.

### TECHNICAL FIELD

The present invention relates to a mass spectrometry device.

### BACKGROUND ART

In a mass spectrometry device such as a liquid chromatograph mass spectrometry device (LC-MS), an ion source for ionizing components in a sample separated in a liquid chromatograph (LC) is used. The ion source is attached to the main body of the mass spectrometry device so as to be openable and closable, and the ion source is opened to a main body at the time of maintenance or the like (refer to, for example, Patent Document 1 below).

A vacuum chamber into which ions generated in an ionization chamber are introduced is formed in the main body. The ionization chamber and the vacuum chamber communicate with each other via a connection pipe called a desolvation line (DL). Ions generated in the ionization chamber are introduced from the ionization chamber into the vacuum chamber through the connection pipe, and mass spectrometry is performed.

The connection pipe is held by a flange portion (DL flange) formed of a disk-shaped member. When the ion source is closed with respect to the main body, the flange portion is pressed toward the main body by the ion source, and the connection pipe is fixed. On the other hand, when the ion source is opened with respect to the main body, the pressing force from the ion source with respect to the flange portion is released, and the flange portion and the connection pipe can be detached.

An O-ring as a sealing member is provided between the ion source and the main body. When the ion source is closed with respect to the main body, the sealing member is pressed and elastically deformed, so that airtightness in the ionization chamber is secured.

### PRIOR ART DOCUMENT

### Patent Document

Patent Document 1: JP-A-2021-82497

### SUMMARY OF THE INVENTION

### Problems to be Solved by the Invention

The mass spectrometry device disclosed in Patent Document 1 is provided with a lock mechanism for locking the ion source in a closed state with respect to the main body. However, in order to sufficiently ensure airtightness in the ionization chamber, when the ion source is closed with respect to the main body, it is necessary to elastically deform the sealing member with a large pressing force and lock the ion source with respect to the main body so as to maintain the state.

In particular, in a small mass spectrometry device, it is desirable to have a configuration in which a large force is applied with a space-saving structure and the ion source can be easily locked to the main body.

The present invention has been made in view of the above circumstances, and an object thereof is to provide a mass spectrometry device capable of easily locking an ion source to a main body with a space-saving structure.

### Means for Solving the Problems

A mass spectrometry device according to the present invention includes an ion source, a main body, a connection pipe, a flange portion, a first sealing member, and a lock mechanism. An ionization chamber for ionizing a sample is formed inside the ion source. A vacuum chamber into which ions generated in the ionization chamber are introduced is formed in the main body, and the ion source is attached to the main body so as to be openable and closable. The connection pipe is detachable from the main body, and introduces ions from the ionization chamber into the vacuum chamber. The flange portion holds the connection pipe, and is pressed toward the main body by a pressing surface formed on the ion source as the ion source is closed with respect to the main body. The first sealing member is provided between the flange portion and the pressing surface. The lock mechanism is for locking the ion source in a closed state with respect to the main body.

The lock mechanism includes a lever and an engaging portion. The lever is provided in the main body or the ion source, and is rotatable between a locked state in which the ion source is maintained in a closed state with respect to the main body and an unlocked state in which the ion source is openable with respect to the main body. The engaging portion includes a first engaging member and a second engaging member at least one of which is rotatably provided, and the first engaging member and the second engaging member are engaged with each other in the locked state. At least one of the first engaging member and the second engaging member rotates while being in contact with each other as the lever rotates from the unlocked state to the locked state.

### Effects of the Invention

According to the present invention, the ion source can be easily locked to the main body with a space-saving structure.

### BRIEF DESCRIPTION OF THE DRAWINGS

FIG. 1 is a schematic view illustrating an example of a mass spectrometry device according to the present embodiment.

FIG. 2 is a schematic sectional view illustrating an example of a peripheral configuration of a connection pipe.

FIG. 3A is a schematic side view illustrating an example of a configuration of a lock mechanism.

FIG. 3B is a schematic side view illustrating an example of a configuration of a lock mechanism.

FIG. 3C is a schematic side view illustrating an example of a configuration of a lock mechanism.

FIG. 4A is a schematic side view for explaining detection of rotation of a lever.

FIG. 4B is a schematic side view for explaining detection of rotation of the lever.

FIG. 5 is a schematic plan view for explaining gas supply into an ionization chamber, and a part thereof is shown in cross section.

FIG. 6 is a schematic sectional view illustrating an example of a configuration of a gas outlet and a periphery of a gas inlet.

### MODE FOR CARRYING OUT THE INVENTION

### 1. Overall Configuration of Mass Spectrometry Device

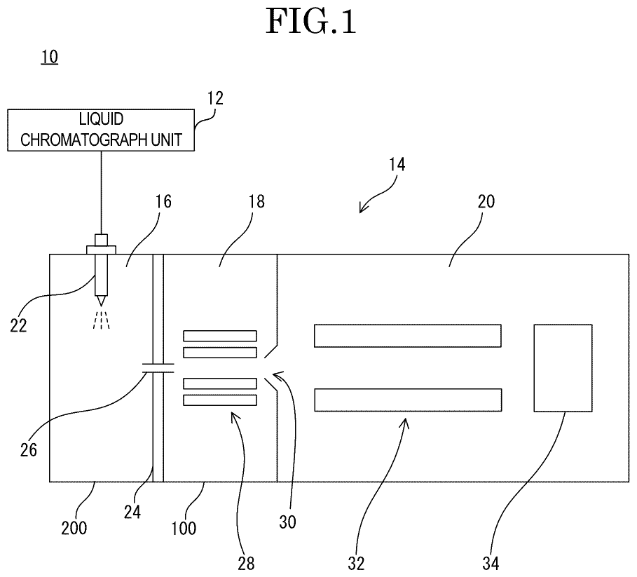

FIG. 1 is a schematic view illustrating an example of a mass spectrometry device 10 according to the present embodiment. The mass spectrometry device 10 illustrated in FIG. 1 is a liquid chromatograph mass spectrometry device that performs mass spectrometry on components in a sample separated by liquid chromatography. The mass spectrometry device 10 includes a liquid chromatograph unit 12 and a mass spectrometry unit 14. The present invention is also applicable to a mass spectrometry device other than the liquid chromatograph mass spectrometry device.

The liquid chromatograph unit 12 includes a column (not shown). During the mass spectrometry, a mobile phase containing an organic solvent is introduced into the column. A predetermined amount of sample is injected into the mobile phase introduced into the column. The mobile phase into which the sample is injected is introduced into the column, and each component in the sample is separated in the process of passing through the column. Each component in the sample separated by the column is sequentially supplied to the mass spectrometry unit 14.

In the mass spectrometry unit 14, an ionization chamber 16, a vacuum chamber 18, and an analysis chamber 20 are formed. The inside of the ionization chamber 16 is substantially at atmospheric pressure. The vacuum chamber 18 and the analysis chamber 20 are each brought into a vacuum state by driving of a vacuum pump (not shown).

The ionization chamber 16 communicates with the vacuum chamber 18, and the analysis chamber 20 communicates with the vacuum chamber 18. That is, the ionization chamber 16 communicates with the analysis chamber 20 via the vacuum chamber 18. The ionization chamber 16, the vacuum chamber 18, and the analysis chamber 20 are configured such that the degree of vacuum increases stepwise in this order.

The ionization chamber 16 is provided with a probe 22. The probe 22 sprays a liquid sample by, for example, electrospray ionization (ESI). In the probe 22, charges are applied to the sample to be sprayed, and charged droplets composed of the charged sample are generated, so that ions derived from each component in the sample are generated. In this manner, in the ionization chamber 16, the sample supplied from the liquid chromatograph unit 12 is ionized.

The ionization chamber 16 and the vacuum chamber 18 are partitioned by a partition wall 24, and a connection pipe 26 penetrates through the partition wall 24. That is, the connection pipe 26 allows the ionization chamber 16 and the vacuum chamber 18 to communicate with each other. The connection pipe 26 is formed of a thin tube called a desolvation line (DL), and is used for desolvation.

The vacuum chamber 18 is provided with an ion guide 28 for sending ions to the analysis chamber 20 while converging the ions. The vacuum chamber 18 communicating with the ionization chamber 16 may be configured in multiple stages.

The analysis chamber 20 communicates with the vacuum chamber 18 via a skimmer 30 including a small hole. Ions generated in the ionization chamber 16 are introduced from the ionization chamber 16 into the vacuum chamber 18 through the connection pipe 26, and then flow into the analysis chamber 20 through the skimmer 30.

The analysis chamber 20 is provided with, for example, a quadrupole filter 32 and a detector 34. Ions flowing from the vacuum chamber 18 into the analysis chamber 20 are separated according to the mass-to-charge ratio by the quadrupole filter 32, and only ions having a specific mass-to-charge ratio pass through the quadrupole filter 32. The ions having passed through the quadrupole filter 32 are incident on the detector 34. In the detector 34, a current corresponding to the number of reached ions is output as a detection signal.

According to such a mass spectrometry device 10, ions generated by ionizing a sample in the ionization chamber 16 are introduced into the vacuum chamber 18, and the ions can be detected by the detector 34.

In the present embodiment, the hollow main body 100 in which the vacuum chamber 18 and the analysis chamber 20 are formed and the hollow ion source 200 in which the ionization chamber 16 is formed are configured as separate members. The connection pipe 26 is detachable from the partition wall 24 provided in the main body 100.

The ion source 200 is attached to the main body 100 so as to be openable and closable, and by closing the ion source 200 with respect to the main body 100, the ion source 200 faces the partition wall 24, and the ionization chamber 16, the vacuum chamber 18, and the analysis chamber 20 are sealed. In addition, by opening the ion source 200 with respect to the main body 100, the connection pipe 26 is exposed to the outside, and maintenance can be performed by detaching the connection pipe 26 from the main body 100.

### 2. Configuration Around Connection Pipe

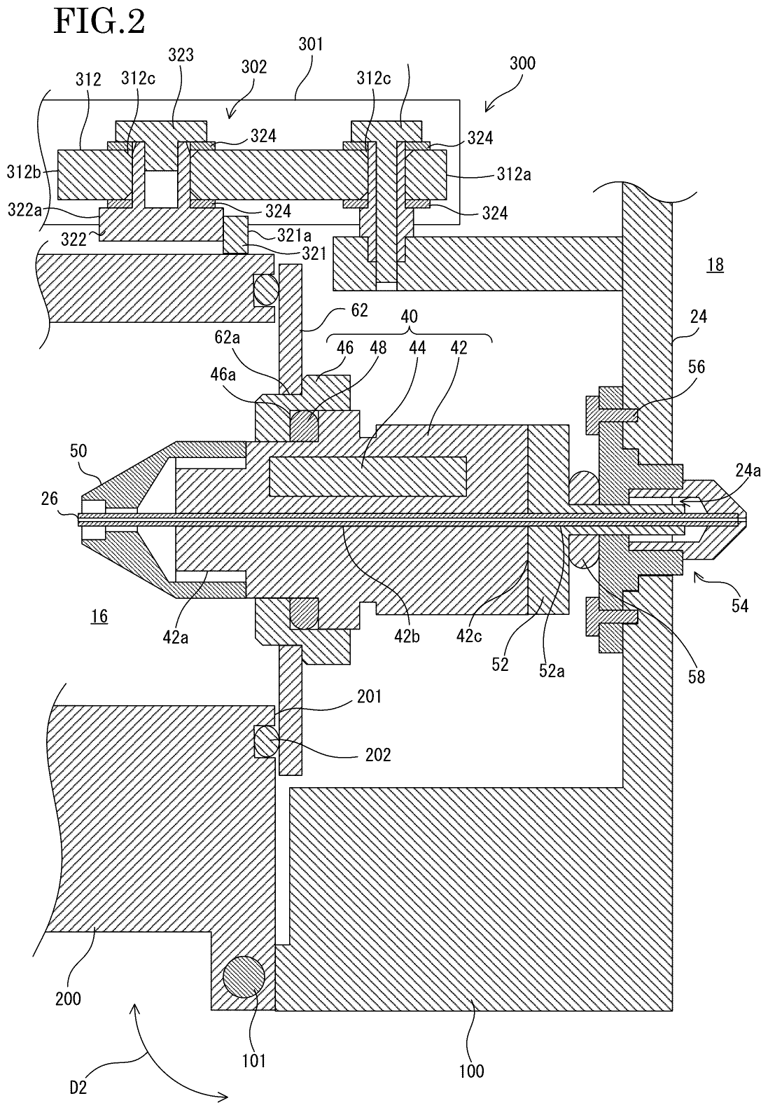

FIG. 2 is a schematic sectional view illustrating an example of a peripheral configuration of a connection pipe 26. The connection pipe 26 is formed of metal having conductivity and thermal conductivity, and is held by a flange portion 62 via a connection body portion 40 as illustrated in FIG. 2.

The connection body portion 40 is provided to heat the connection pipe 26 and surrounds the outer periphery of the connection pipe 26. The connection body portion 40 includes a heating block 42, a heater 44, a cylindrical member 46, a sealing member 48, and the like.

The heating block 42 is formed of a metal having conductivity and thermal conductivity. The heating block 42 includes a protrusion 42a protruding toward the ionization chamber 16.

Further, a through hole 42b extending in a longitudinal direction is formed in the heating block 42. The connection pipe 26 is inserted into the through hole 42b so as to be in contact with the inner peripheral surface of the through hole 42b. That is, the heating block 42 surrounds the outer periphery of the connection pipe 26.

The heater 44 is in contact with the heating block 42. The heat of the heater 44 is transferred to the connection pipe 26 via the heating block 42, whereby the connection pipe 26 is heated.

Accordingly, the connection body portion 40 heats the connection pipe 26 inserted into the connection body portion 40. Note that illustration of wiring or the like for supplying electric power to the heater 44 is omitted.

The cylindrical member 46 has a through hole 46a whose diameter changes stepwise, and the heating block 42 is inserted into the through hole 46a so as to be in contact with the inner peripheral surface of the through hole 46a.

The sealing member 48 includes, for example, an O-ring. The heating block 42 is inserted inside the sealing member 48, and the outside of the sealing member 48 abuts on the inside of the cylindrical member 46. The sealing member 48 is sandwiched between the heating block 42 and the cylindrical member 46 in an axial direction of the connection pipe 26.

A sampling cone 50 is attached to the connection body portion 40. The sampling cone 50 is an interface for drawing ions on the ionization chamber 16 side into the connection pipe 26, and is formed of a conductive metal.

The sampling cone 50 is provided on the ionization chamber 16 side with respect to the connection body portion 40. The sampling cone 50 is a cylindrical body having a conical shape, and an end portion of the connection pipe 26 is inserted therethrough. Further, the protrusion 42a of the heating block 42 is inserted inside the sampling cone 50.

A holding member 52 is provided on the vacuum chamber 18 side with respect to the connection body portion 40. The holding member 52 is formed of a metal having conductivity and thermal conductivity. A through hole 52a is formed in the holding member 52, and the end portion of the connection pipe 26 is inserted into the through hole 52a and held so as to be in contact with the inner peripheral surface of the through hole 52a. The holding member 52 is fixed to the connection pipe 26 by welding a part thereof to the connection pipe 26. Therefore, by displacing the holding member 52 along the axial direction of the connection pipe 26, the connection pipe 26 held by the holding member 52 can be removed from the through hole 42b of the heating block 42 to perform maintenance.

The holding member 52 is in contact with an entire end face 42c of the heating block 42. Accordingly, the heat transferred from the heater 44 to the heating block 42 is favorably transferred from the end face 42c to the holding member 52. A part of the holding member 52 is inserted into an opening 24a of the partition wall 24 while protruding toward the vacuum chamber 18. With such a configuration, the connection pipe 26 is inserted into the opening 24a.

An orifice member 54 is provided in the opening 24a of the partition wall 24. The orifice member 54 is an interface for introducing ions into the vacuum chamber 18. The orifice member 54 is fixed to the partition wall 24 using a fixture 56 such as a screw. The sealing member 58 is sandwiched between the holding member 52 and the orifice member 54.

The ion source 200 is attached to the main body 100 so as to be rotatable about a rotation shaft 101. The main body 100 and the ion source 200 are connected to each other via a hinge (not shown) made of stainless steel, for example, and the hinge is provided with a rotation shaft 101. The rotation shaft 101 may be held by a hinge via a bearing including, for example, a metal cermet oil bush.

By rotating the ion source 200 about the rotation shaft 101, the ion source 200 can be opened and closed with respect to the main body 100. FIG. 2 illustrates a state in which the ion source 200 is closed with respect to the main body 100. Note that the ion source 200 is not limited to be rotatable with respect to the main body 100, and may be configured to be openable with respect to the main body 100 by another mode such as sliding with respect to the main body 100.

In a state where the ion source 200 is closed with respect to the main body 100, a pressing surface 201 of the ion source 200 faces the flange portion 62. The flange portion 62 is a so-called DL flange and is formed of a disk-shaped member. A through hole 62a is formed in the flange portion 62, and the connection body portion 40 (cylindrical member 46) is inserted into the through hole 62a.

In the example illustrated in FIG. 2, as the ion source 200 is closed with respect to the main body 100, the flange portion 62 is pressed toward the main body 100 side by the pressing surface 201 of the ion source 200. As a result, the flange portion 62 presses the connection body portion 40 via the cylindrical member 46, and accordingly, the holding member 52 is pressed toward the vacuum chamber 18. When the connection body portion 40 is pressed by the flange portion 62, each of the sealing member 48 and the sealing member 58 is elastically deformed.

A sealing member 202 as a first sealing member is provided between the flange portion 62 and the pressing surface 201 of the ion source 200. In this example, the sealing member 202 is an annular O-ring and is fixed in a recess provided in the pressing surface 201. The sealing member 202 is formed of, for example, low-friction non-adhesive fluororubber which is difficult to be fixed. However, the sealing member 202 is not limited to be attached to the pressing surface 201, and may be attached to the flange portion 62.

The ion source 200 is locked in a closed state with respect to the main body 100 by the lock mechanism 300. In the locked state illustrated in FIG. 2, since the ion source 200 is locked by the lock mechanism 300, the ion source 200 cannot be rotated about the rotation shaft 101, and the ion source 200 is maintained in a closed state with respect to the main body 100. In the locked state, the sealing member 202 is elastically deformed, and airtightness of the ionization chamber 16 is secured.

### 3. Configuration of Lock Mechanism

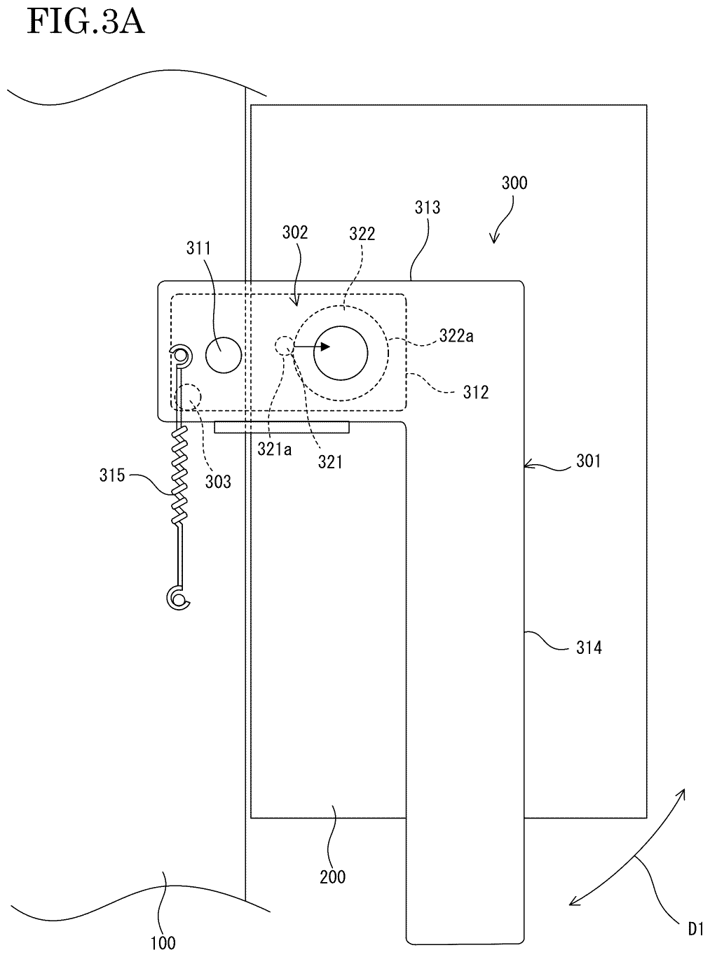

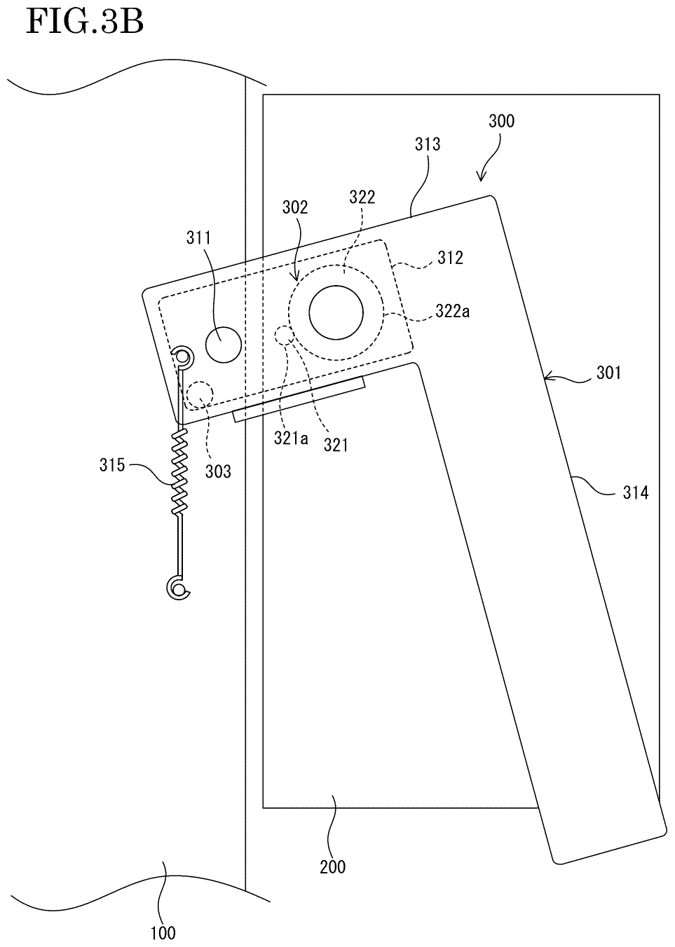

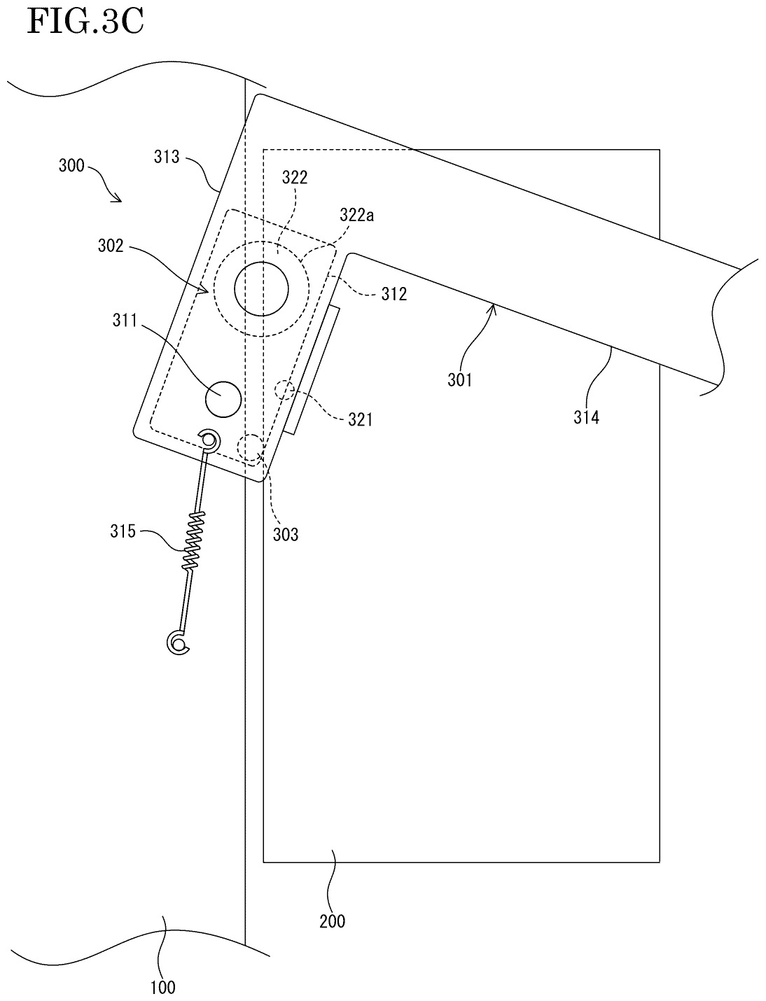

FIGS. 3A to 3C are schematic side views illustrating an example of the configuration of the lock mechanism 300. Hereinafter, a specific configuration and operation of the lock mechanism 300 will be described with reference to FIGS. 2 and 3A to 3C.

The lock mechanism 300 includes a lever 301 and an engaging portion 302. The engaging portion 302 includes a first engaging member 321 and a second engaging member 322 that can be engaged with each other. The lock mechanism 300 can change the engagement state between the first engaging member 321 and the second engaging member 322 based on the operation of the lever 301 by the user.

The lever 301 is attached to the main body 100 so as to be rotatable about a rotation shaft 311. The rotation shaft 311 extends in a direction intersecting with the rotation shaft 101 of the ion source 200, more specifically, in an orthogonal direction. Therefore, the rotation direction D1 of the lever 301 about the rotation shaft 311 is different from the rotation direction D2 of the ion source 200 about the rotation shaft 101.

The lever 301 includes a support plate 312, and a rotation shaft 311 inserted through an insertion hole 312a formed in the support plate 312 is fixed to the main body 100. The lever 301 is formed of, for example, an L-shaped member in a side view by connecting a base portion 313 provided with the support plate 312 and an operation unit 314 for the user to operate. However, the shape of the lever 301 is not limited to such a shape.

The second engaging member 322 is provided on the lever 301 by being rotatably attached to the support plate 312. Specifically, the second engaging member 322 is inserted into an insertion hole 312b formed in the support plate 312 from one side, and a fastener 323 is attached from the other side of the insertion hole 312b, whereby the second engaging member 322 is rotatably supported in the insertion hole 312b.

Corner portions of the insertion hole 312b facing the second engaging member 322, that is, corner portions constituting both end edges of the insertion hole 312b are chamfered by being scraped so as to form the tapered surface 312c. As a result, the second engaging member 322 can be smoothly rotated in the insertion hole 312b.

The engaging portion 302 includes a thrust washer 324 provided between the insertion hole 312b and the second engaging member 322. The thrust washer 324 is an annular washer for smoothing rotation, and is provided at both end edges of the insertion hole 312b. One thrust washer is sandwiched between the head portion of the second engaging member 322 and the support plate 312, and the other thrust washer is sandwiched between the fastener 323 and the support plate 312. As a result, the second engaging member 322 can be more smoothly rotated in the insertion hole 312b. A bearing may be provided between the insertion hole 312b and the second engaging member 322.

Similarly, a corner portion of the insertion hole 312a facing the rotation shaft 311, that is, a corner portion constituting both end edges of the insertion hole 312a is also chamfered by being scraped so as to form the tapered surface 312c. The thrust washers 324 are also sandwiched between both end edges of the insertion hole 312a and the rotation shaft 311. As a result, the support plate 312 (lever 301) can be smoothly rotated about the rotation shaft 311.

The first engaging member 321 is provided in the ion source 200 by being rotatably attached to the ion source 200. The rotation shaft of the first engaging member 321 is parallel to the rotation shaft of the second engaging member 322. An outer peripheral surface of the first engaging member 321 is a first contact surface 321a formed of a circumferential surface, and can be brought into contact with the outer peripheral surface of the second engaging member 322 which is a second contact surface 322a formed of a circumferential surface in accordance with the rotation of the lever 301 about the rotation shaft 311.

In the state of FIGS. 2, 3A, and 3B, the first contact surface 321a of the first engaging member 321 and the second contact surface 322a of the second engaging member 322 are in contact with each other, but in the state of FIG. 3C, the first contact surface 321a of the first engaging member 321 and the second contact surface 322a of the second engaging member 322 are not in contact with each other. However, at least one of the first contact surface 321a and the second contact surface 322a is not a circumferential surface, and may be another circumferential surface such as an arc surface or a surface other than the circumferential surface.

The state illustrated in FIGS. 2 and 3A is a locked state in which the ion source 200 is maintained in a closed state with respect to the main body 100. In this state, the first engaging member 321 and the second engaging member 322 are engaged with each other. Specifically, the outer peripheral surface of the first engaging member 321 and the outer peripheral surface of the second engaging member 322 are in contact with each other, and the restoring force of the elastically deformed sealing member 202 acts on the second engaging member 322 from the first engaging member 321 as indicated by an arrow in FIG. 3A. In this state, since the center (rotation shaft) of the first engaging member 321 is located on the opposite side to the rotation direction of the lever 301 at the time of locking from the straight line connecting the center (rotation shaft) of the rotation shaft 311 and the center (rotation shaft) of the second engaging member 322, it is possible to prevent the locked state from being released when an external force such as an impact is applied to the ion source 200 in the locked state.

The lever 301 has a base portion 313 connected to the main body 100 via a tension spring 315. As a result, a rotational force acts on the lever 301 in the counterclockwise direction in FIG. 3A around the rotation shaft 311. However, in the state of FIG. 3A, since the resistance force acting between the first engaging member 321 and the second engaging member 322 is large, the lever 301 does not rotate, and the locked state is maintained unless the user operates the lever 301.

When the lever 301 is rotated counterclockwise from the locked state in FIG. 3A, each of the first engaging member 321 and the second engaging member 322 rotates while the first contact surface 321a of the first engaging member 321 and the second contact surface 322a of the second engaging member 322 are in contact with each other. At this time, due to the force acting on the lever 301 from the tension spring 315, the lever 301 can be easily rotated with a small force.

As described above, as the lever 301 rotates, each of the first engaging member 321 and the second engaging member 322 rotates, and as illustrated in FIG. 3B, the ion source 200 enters an unlocked state that can be opened with respect to the main body 100. When the lever 301 is further rotated counterclockwise from the unlocked state in FIG. 3, the first contact surface 321a of the first engaging member 321 and the second contact surface 322a of the second engaging member 322 are separated from each other.

In a negative pressure state in the ionization chamber 16 or a state in which the sealing member 202 is fixed to the flange portion 62, even if the lever 301 is rotated from the locked state to the unlocked state, the ion source 200 is not opened with respect to the main body 100 only by the restoring force of the sealing member 202. Therefore, in the present embodiment, as the lever 301 is further rotated counterclockwise from the unlocked state, as illustrated in FIG. 3C, a pressing member 303 provided on the support plate 312 comes into contact with the ion source 200, and the ion source 200 is pressed in a direction away from the main body 100.

Thus, the ion source 200 can be forcibly opened with respect to the main body 100 only by operating the lever 301. However, the pressing member 303 is not limited to the configuration provided on the support plate 312, and may be provided in another portion of the lock mechanism 300 such as the lever 301.

When the ion source 200 is closed with respect to the main body 100, an operation opposite to the above operation is performed. That is, after closing the ion source 200 with respect to the main body 100, the user rotates the lever 301 from the unlocked state of FIG. 3B to the locked state of FIG. 3A. When the ion source 200 is closed with respect to the main body 100, the first engaging member 321 and the second engaging member 322 come into contact with each other before the sealing member 202 comes into contact with the flange portion 62. Therefore, it is not necessary to manually apply a force against the repulsive force of the sealing member 202 to the ion source 200 when closing the ion source 200, and it is possible to easily lock the ion source 200 with respect to the main body 100 by applying a large force only by operating the lever 301.

As the lever 301 is rotated from the unlocked state to the locked state, the first engaging member 321 and the second engaging member 322 rotate while being in contact with each other. Specifically, as the lever 301 is rotated from the unlocked state to the locked state, each of the first engaging member 321 and the second engaging member 322 rotates while the first contact surface 321a of the first engaging member 321 and the second contact surface 322a of the second engaging member 322 are in contact with each other.

As a result, it is possible to lock the ion source 200 in a closed state with respect to the main body 100 against the restoring force of the sealing member 202 indicated by the arrow in FIG. 3A while pressing the sealing member 202 against the flange portion 62.

A radius of the second contact surface 322a of the second engaging member 322 is larger than a radius of the first contact surface 321a of the first engaging member 321. The ratio of these radii is not particularly limited, but as the radius of the second contact surface 322a is larger than the radius of the first contact surface 321a, the lever 301 can be rotated from the unlocked state to the locked state with a smaller force.

However, the configuration is not limited to the configuration in which the lever 301 is provided in the main body 100, and the lever 301 may be provided in the ion source 200. That is, the ion source 200 may be locked in a closed state with respect to the main body 100 by rotating the lever 301 provided in the ion source 200 from the unlocked state to the locked state. Further, both the first engaging member 321 and the second engaging member 322 are not limited to be rotatable, and only one may be rotatable.

### 4. Detection of Rotation of Lever

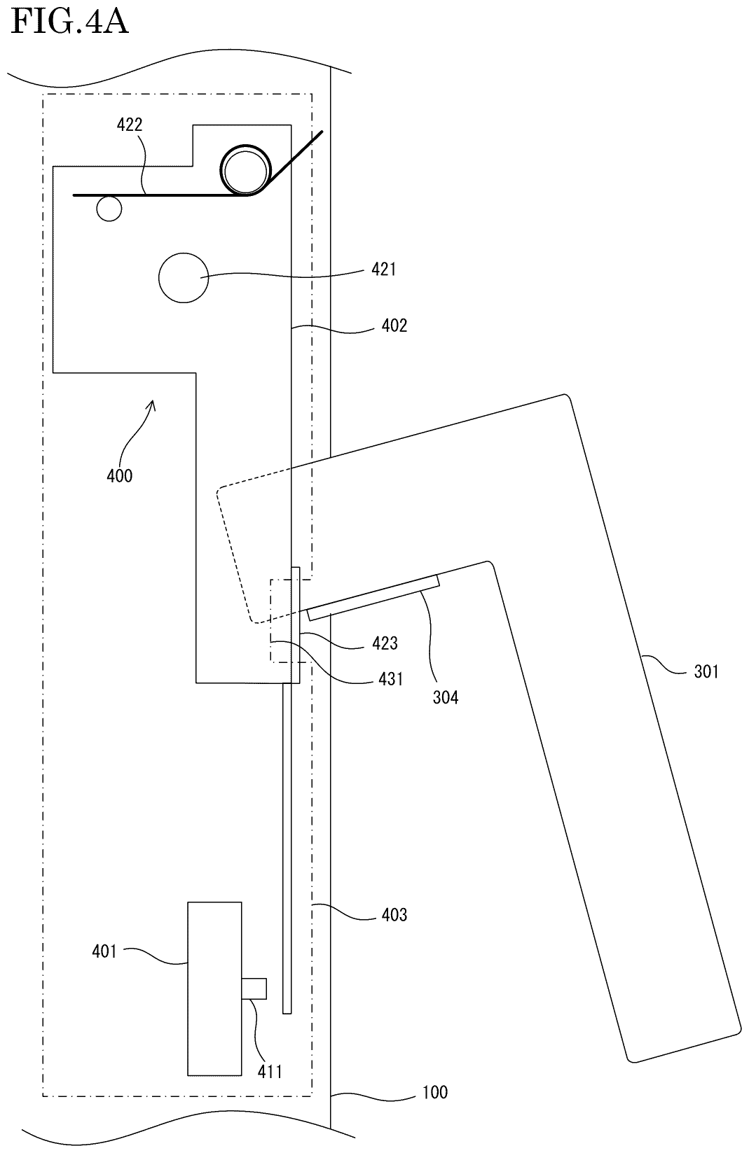

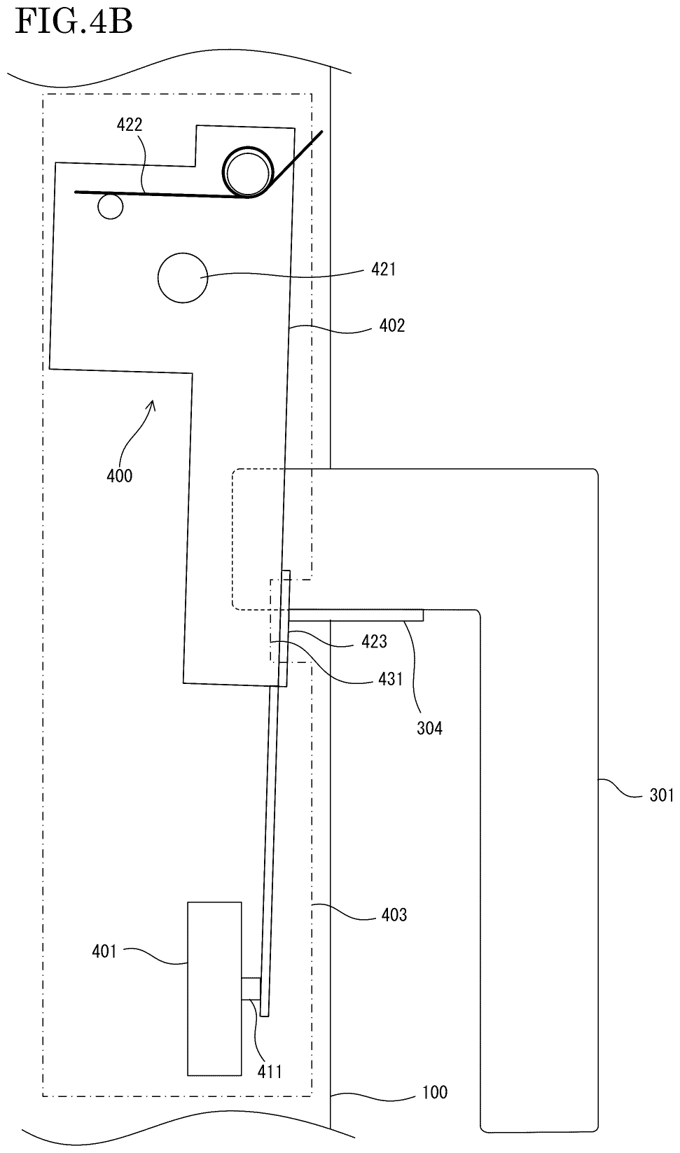

FIG. 4A and FIG. 4B are schematic side views for explaining detection of rotation of the lever 301. The main body 100 is provided with a detection unit 400 for detecting the rotation of the lever 301. The detection unit 400 includes a switch 401 and a driven portion 402.

The switch 401 is, for example, a micro switch, and detects the presence or absence of contact of the driven portion 402 with a contact 411. In a state where the driven portion 402 is not in contact with the contact 411 as illustrated in FIG. 4A, the switch 401 is in an off state, and when the driven portion 402 is in contact with the contact 411 as illustrated in FIG. 4B, the switch 401 is in an on state.

The driven portion 402 is rotatable about a rotation shaft 421 attached to the main body 100. The rotation shaft 421 of the driven portion 402 is parallel to the rotation shaft 311 of the lever 301. A biasing member 422 including, for example, a torsion spring is attached to the driven portion 402, and the driven portion 402 is biased counterclockwise in FIG. 4A by the biasing member 422. However, in the state of FIG. 4A, the driven portion 402 is in contact with a stopper (not shown), and is regulated so as not to rotate counterclockwise from this state.

In the state of FIG. 4A, the lever 301 is in an unlocked state, and in this state, the lever 301 is not in contact with the driven portion 402. When the lever 301 is rotated clockwise from the state of FIG. 4A, the contact portion 304 provided on the lever 301 comes into contact with a contacted portion 423 provided on the driven portion 402. When the lever 301 is further rotated clockwise, the contacted portion 423 is pressed by the contact portion 304 against the biasing force of the biasing member 422, and the driven portion 402 rotates clockwise about the rotation shaft 421.

When the lever 301 is rotated to the locked state as illustrated in FIG. 4B, a part of the driven portion 402 comes into contact with the contact 411 of the switch 401, and the switch 401 is switched from the off state to the on state. A controller (not shown) can detect that the lever 301 is in the locked state based on a signal when the switch 401 is switched from the off state to the on state.

On the other hand, when the lever 301 is rotated from the locked state in FIG. 4B to the unlocked state in FIG. 4A, the switch 401 is switched from the on state to the off state. In this case, the controller can detect that the lever 301 is in the unlocked state based on a signal when the switch 401 is switched from the on state to the off state.

The outer side of the detection unit 400 is covered with a cover member 403. In the cover member 403, a notch 431 is formed in a portion facing a non-contact portion 423, and the contact portion 304 of the lever 301 can enter the inside of the cover member 403 via the notch 431. Since the portion of the detection unit 400 other than the notch 431 is covered with the cover member 403, it is possible to prevent the user from inadvertently touching the detection unit 400. In addition, it is possible to prevent the electromagnetic noise from entering from the outside of the device via the detection unit 400, and it is possible to prevent the electromagnetic noise from adversely affecting the analysis result.

### 5. Gas Supply into Ionization Chamber

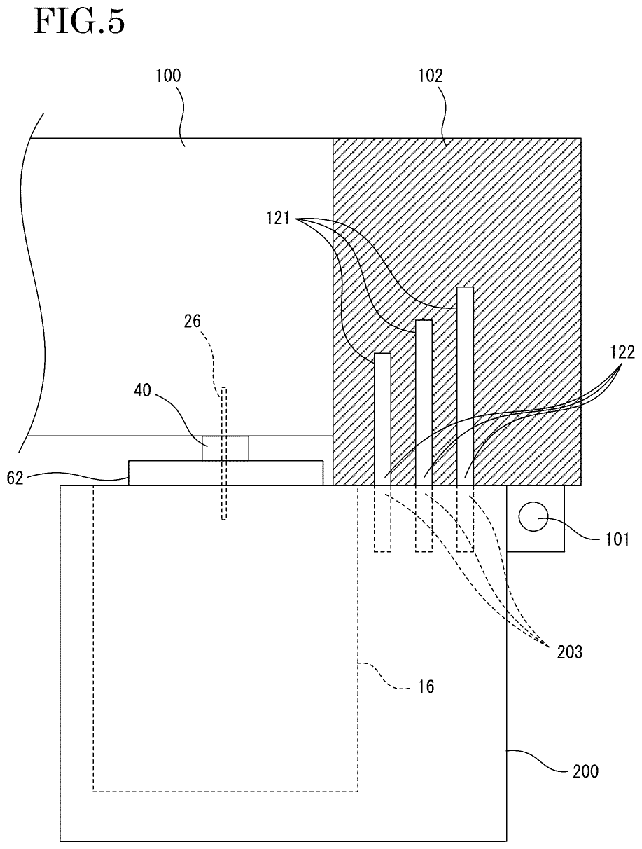

FIG. 5 is a schematic plan view for explaining gas supply into the ionization chamber 16, and a part thereof is shown in cross section. In the present embodiment, a gas (dry gas) is supplied into the ionization chamber 16 in order to promote desolvation of the charged droplets.

The main body 100 is provided with a manifold 102 which is a block for supplying gas to the ion source 200. A plurality of gas supply paths 121 are formed in the manifold 102. In this example, three gas supply paths 121 are formed, but the present invention is not limited thereto, and a configuration in which two or less or four or more gas supply paths 121 are formed may be adopted.

As illustrated in FIG. 5, the manifold 102 of the main body 100 faces the ion source 200 in proximity to the ion source 200 in a state where the ion source 200 is closed. Each of the gas supply paths 121 is opened via a gas outlet 122 at a position facing the ion source 200, and the gas in each of the gas supply paths 121 is led out from each of the gas outlets 122.

In the ion source 200, a gas inlet 203 is formed at a position facing the manifold 102 of the main body 100 in a state where the ion source 200 is closed. The number of the gas inlets 203 is the same as the number of the gas outlets 122, and in a state where the ion source 200 is closed, each of the gas inlets 203 faces each of the gas outlets 122 in proximity thereto. As a result, the gas led out from each gas outlet 122 through each gas supply path 121 of the main body 100 is introduced into the ion source 200 from each gas inlet 203. The gas introduced from each gas inlet 203 into the ion source 200 is supplied into the ionization chamber 16 through a pipe (not shown).

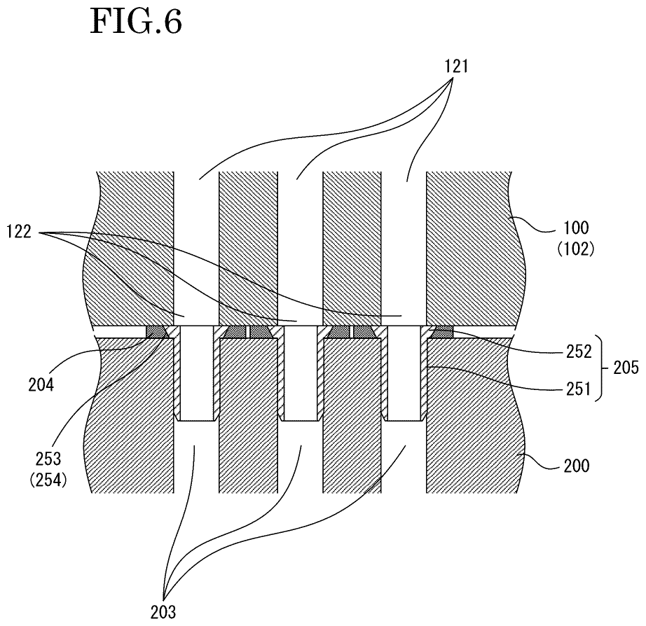

FIG. 6 is a schematic sectional view illustrating an example of a configuration of the gas outlet 122 and a periphery of the gas inlet 203. As illustrated in FIG. 6, in a state where the ion source 200 is closed with respect to the main body 100, the sealing member 204 as the second sealing member is sandwiched in a compressed state between the main body 100 (manifold 102) and the ion source 200.

Each sealing member 204 is attached to a peripheral edge portion of each gas inlet 203. Each of the sealing members 204 is an annular O-ring, and is formed of, for example, low-friction non-adhesive fluororubber which is difficult to be fixed. An inner diameter of each sealing member 204 is larger than an inner diameter of each gas inlet 203.

Each sealing member 204 is fixed to the ion source 200 using a fixing member 205. The fixing member 205 is a threaded member in which a shaft portion 251 and a head portion 252 are integrally formed, and is fixed by being screwed into the ion source 200. In general, the higher the temperature of the O-ring, the more easily the O-ring is fixed. The ion source 200 has a higher temperature than the manifold 102 due to the heat of the heating assist gas that promotes desolvation. By fixing each sealing member 204 to the ion source 200 side at a high temperature, each sealing member 204 can be firmly fixed to the ion source 200 by the force of fixing to the ion source 200, and it is difficult to fix to the manifold 102 at a low temperature, so that it is possible to prevent the sealing member 204 from being fixed to the manifold 102 and falling off from the fixing member 205.

The shaft portion 251 of the fixing member 205 is a hollow member formed in a cylindrical shape. An outer diameter of the shaft portion 251 substantially coincides with an inner diameter of the gas inlet 203, a thread is formed on an outer peripheral surface of the shaft portion 251, and a thread groove corresponding to the thread is formed in the gas inlet 203. The shaft portion 251 is inserted through the sealing member 204 and screwed into the gas inlet 203 of the ion source 200.

The head portion 252 of the fixing member 205 is an annular member provided at one end portion of the shaft portion 251. The outer diameter of the head portion 252 is larger than the outer diameter of the shaft portion 251. Thus, the head portion 252 is formed in a flange shape so as to protrude in a radial direction from the outer peripheral surface of the shaft portion 251. An abutting surface 253 abutting on the sealing member 204 is formed on the head portion 252, and the sealing member 204 is pressed toward the ion source 200 and fixed by the abutting surface 253.

The abutting surface 253 constitutes an outer peripheral surface of the head portion 252, and is formed by a tapered surface 254 tapered toward the ion source 200 (shaft portion 251). That is, the head portion 252 is formed such that the outer diameter gradually decreases toward the shaft portion 251.

When the shaft portion 251 of the fixing member 205 is inserted into the sealing member 204 and the shaft portion 251 is screwed into the gas inlet 203 of the ion source 200, the inner peripheral surface of the sealing member 204 is elastically deformed by the abutting surface 253 of the head portion 252, and the inner peripheral surface becomes a tapered surface along the abutting surface 253. As a result, the sealing member 204 is more firmly fixed to the ion source 200.

In a state where the ion source 200 is not closed with respect to the main body, that is, in a state where each sealing member 204 is not in contact with the manifold 102, the thickness of the head portion 252 is equal to or less than the thickness of the sealing member 204. As described above, by setting the thickness of the head portion 252 to be equal to or less than the thickness of the sealing member 204, it is possible to provide a configuration in which the fixing member 205 (head portion 252) does not protrude toward the main body 100 from the sealing member 204. Therefore, it is not necessary to provide a structure in which the fixing member 205 enters the gas outlet 122 provided in the manifold 102. Therefore, even when the position of the ion source 200 is displaced due to a manufacturing error or an assembly error of each member and the center position of the gas outlet 122 and the center position of the gas inlet 203 are displaced, it is possible to prevent the fixing member 205 from coming into contact with the manifold 102 to cause a gas seal failure or to cause cutting powder or the like.

### 6. Aspects

It is understood by those skilled in the art that the plurality of exemplary embodiments described above are specific examples of the following aspects.

(Aspect 1) According to an aspect, a mass spectrometry device may include:
an ion source in which an ionization chamber for ionizing a sample is formed;
a main body in which a vacuum chamber into which ions generated in the ionization chamber are introduced is formed and to which the ion source is attached in an openable and closable manner;
a connection pipe attachable to and detachable from the main body and configured to introduce ions from the ionization chamber into the vacuum chamber;
a flange portion that holds the connection pipe and is pressed toward the main body by a pressing surface formed on the ion source as the ion source is closed with respect to the main body;
a first sealing member provided between the flange portion and the pressing surface; and
a locking mechanism for locking the ion source in a closed state with respect to the main body,
in which the lock mechanism may include:
   a lever that is provided in the main body or the ion source and is rotatable between a locked state in which the ion source is maintained in a closed state with respect to the main body and an unlocked state in which the ion source is openable with respect to the main body; and
   an engaging portion which includes a first engaging member and a second engaging member at least one of which is rotatably provided, and in which the first engaging member and the second engaging member are engaged with each other in the locked state, and
at least one of the first engaging member and the second engaging member may rotate while contacting each other as the lever rotates from the unlocked state to the locked state.

According to the mass spectrometry device described in Aspect 1, by rotating the lever from the unlocked state to the locked state, at least one of the first engaging member and the second engaging member is rotated while being in contact with each other, and the ion source can be locked in a closed state with respect to the main body. As a result, since the lever can be rotated with a small force to be in a locked state, the ion source can be easily locked to the main body with a space-saving structure.

(Aspect 2) The mass spectrometry device described in Aspect 1,
in which the first engaging member and the second engaging member may be provided so as to be rotatable with respect to rotation shafts parallel to each other, and
as the lever rotates from the unlocked state to the locked state, each of the first engaging member and the second engaging member may rotate while a circumferential first contact surface formed on the first engaging member and a circumferential second contact surface formed on the second engaging member are in contact with each other.

According to the mass spectrometry device described in Aspect 2, since both the first engaging member and the second engaging member are rotatable, the lever can be rotated with a smaller force to be in the locked state.

(Aspect 3) The mass spectrometry device described in Aspect 2,
in which the first engaging member may be provided in the ion source, and the second engaging member may be provided in the lever, and
a radius of the second contact surface may be larger than a radius of the first contact surface.

According to the mass spectrometry device described in Aspect 3, the lever can be rotated with a smaller force to be in the locked state.

(Aspect 4) The mass spectrometry device described in Aspect 3,
in which the lever may include a support plate that rotatably supports the second engaging member, and
an insertion hole through which the second engaging member is rotatably inserted may be formed in the support plate, and a corner portion of the insertion hole facing the second engaging member may be chamfered.

According to the mass spectrometry device described in Aspect 4, since the second engaging member can be smoothly rotated in the insertion hole, the lever can be rotated with a smaller force to be in the locked state.

(Aspect 5) The mass spectrometry device described in Aspect 4,
in which the engaging portion may further include a thrust washer provided between the insertion hole and the second engaging member.

According to the mass spectrometry device described in Aspect 5, since the second engaging member can be more smoothly rotated in the insertion hole, the lever can be rotated with a smaller force to be in the locked state.

(Aspect 6) The mass spectrometry device described in Aspect 1,
in which when the ion source is closed with respect to the main body, the first engaging member and the second engaging member may come into contact with each other before the first sealing member comes into contact with the flange portion or the pressing surface.

According to the mass spectrometry device described in Aspect 6, it is not necessary to manually apply a force against the repulsive force of the sealing member to the ion source when closing the ion source, and it is possible to easily lock the ion source with respect to the main body by applying a large force only by operating the lever.

(Aspect 7) The mass spectrometry device described in Aspect 1,
in which the lever may be rotatably provided with respect to the main body.

According to the mass spectrometry device described in Aspect 7, the ion source can be locked in a closed state with respect to the main body by rotating the lever rotatable with respect to the main body from the unlocked state to the locked state.

(Aspect 8) The mass spectrometry device described in Aspect 7, may further include:
a detection unit provided in the main body and configured to detect rotation of the lever, and
a cover member that covers an outer side of the detection unit.

According to the mass spectrometry device described in Aspect 8, it is possible to detect that the lever is in the locked state or the unlocked state. In addition, since the outer side of the detection unit is covered with the cover member, it is possible to prevent the user from inadvertently touching the detection unit. In addition, it is possible to prevent the electromagnetic noise from entering from the outside of the device via the detection unit, and it is possible to prevent the electromagnetic noise from adversely affecting the analysis result.

(Aspect 9) The mass spectrometry device described in Aspect 7,
in which the lock mechanism may further include a pressing member that presses the ion source in a direction away from the main body as the lever rotates from the locked state to the unlocked state and further rotates from the unlocked state.

According to the mass spectrometry device described in Aspect 9, the pressing member presses the ion source in a direction away from the main body only by operating the lever, and the ion source can be forcibly opened with respect to the main body.

(Aspect 10) The mass spectrometry device described in Aspect 1,
in which a gas outlet through which a gas to be supplied into the ionization chamber is led out may be formed in the main body, and
in the ion source, a gas inlet which is close to the gas outlet in a state where the ion source is closed with respect to the main body and into which gas from the gas outlet is introduced may be formed, and an annular second sealing member may be attached to a peripheral edge portion of the gas inlet.

According to the mass spectrometry device described in Aspect 10, by closing the ion source with respect to the main body, the gas outlet of the main body and the gas inlet of the ion source can communicate with each other in a state of being sealed by the second sealing member.

(Aspect 11) The mass spectrometry device described in Aspect 10, may further include:
a fixing member that fixes the second sealing member to the ion source by being screwed into the ion source, in which the fixing member may include a hollow shaft portion that is inserted into the second sealing member and screwed into the ion source, and an annular head portion that is provided at one end portion of the shaft portion and presses the second sealing member toward the ion source,
in a state where the ion source is not closed with respect to the main body, a thickness of the head portion may be equal to or less than a thickness of the second sealing member, and
an abutting surface of the head portion with the second sealing member may include a tapered surface tapered toward the ion source.

According to the mass spectrometry device described in Aspect 11, since the fixing member can be configured not to protrude toward the main body from the sealing member, even in a case where the position of the ion source is displaced, the second sealing member can be elastically deformed well without the fixing member coming into contact with the main body, and it is possible to prevent generation of cutting powder or the like due to the contact of the fixing member with the main body. In addition, by fixing the second sealing member to the ion source side at a high temperature, the second sealing member can be firmly fixed to the ion source by the force of fixing to the ion source, and it is difficult to fix to the main body at a low temperature, so that it is possible to prevent the second sealing member from being fixed to the main body and falling off from the fixing member.

### DESCRIPTION OF REFERENCE SIGNS

10 mass spectrometry device
16 ionization chamber
18 vacuum chamber
26 connection pipe
62 flange portion
100 main body
101 rotation shaft
122 gas outlet
200 ion source
201 pressing surface
202 sealing member
203 gas inlet
204 sealing member
205 fixing member
251 shaft portion
252 head portion
253 abutting surface
254 tapered surface
300 lock mechanism
301 lever
302 engaging portion
303 pressing member
311 rotation shaft
312a insertion hole
312b insertion hole
312c tapered surface
312 support plate
321 first engaging member
321a first contact surface
322 second engaging member
322a second contact surface
324 thrust washer
400 detection unit
403 cover member

1. A mass spectrometry device comprising:
an ion source in which an ionization chamber for ionizing a sample is formed;
a main body in which a vacuum chamber into which ions generated in the ionization chamber are introduced is formed and to which the ion source is attached in an openable and closable manner;
a connection pipe attachable to and detachable from the main body and configured to introduce ions from the ionization chamber into the vacuum chamber;
a flange portion that holds the connection pipe and is pressed toward the main body by a pressing surface formed on the ion source as the ion source is closed with respect to the main body;
a first sealing member provided between the flange portion and the pressing surface; and
a locking mechanism for locking the ion source in a closed state with respect to the main body,
wherein the locking mechanism includes:
a lever that is provided in the main body or the ion source and is rotatable between a locked state in which the ion source is maintained in a closed state with respect to the main body and an unlocked state in which the ion source is openable with respect to the main body; and
an engaging portion which includes a first engaging member and a second engaging member at least one of which is rotatably provided, and in which the first engaging member and the second engaging member are engaged with each other in the locked state, and
at least one of the first engaging member and the second engaging member rotates while contacting each other as the lever rotates from the unlocked state to the locked state.

2. The mass spectrometry device according to claim 1,
wherein the first engaging member and the second engaging member are provided so as to be rotatable with respect to rotation shafts parallel to each other, and
as the lever rotates from the unlocked state to the locked state, each of the first engaging member and the second engaging member rotates while a circumferential first contact surface formed on the first engaging member and a circumferential second contact surface formed on the second engaging member are in contact with each other.

3. The mass spectrometry device according to claim 2,
wherein the first engaging member is provided in the ion source, and the second engaging member is provided in the lever, and
a radius of the second contact surface is larger than a radius of the first contact surface.

4. The mass spectrometry device according to claim 3,
wherein the lever includes a support plate that rotatably supports the second engaging member, and
an insertion hole through which the second engaging member is rotatably inserted is formed in the support plate, and a corner portion of the insertion hole facing the second engaging member is chamfered.

5. The mass spectrometry device according to claim 4, wherein the engaging portion further includes a thrust washer provided between the insertion hole and the second engaging member.

6. The mass spectrometry device according to claim 1, wherein when the ion source is closed with respect to the main body, the first engaging member and the second engaging member come into contact with each other before the first sealing member comes into contact with the flange portion or the pressing surface.

7. The mass spectrometry device according to claim 1, wherein the lever is rotatably provided with respect to the main body.

8. The mass spectrometry device according to claim 7, further comprising:
a detection unit provided in the main body and configured to detect rotation of the lever; and
a cover member that covers an outer side of the detection unit.

9. The mass spectrometry device according to claim 7, wherein the lock mechanism further includes a pressing member that presses the ion source in a direction away from the main body as the lever rotates from the locked state to the unlocked state and further rotates from the unlocked state.

10. The mass spectrometry device according to claim 1,
wherein a gas outlet through which a gas to be supplied into the ionization chamber is led out is formed in the main body, and
in the ion source, a gas inlet which is close to the gas outlet in a state where the ion source is closed with respect to the main body and into which gas from the gas outlet is introduced is formed, and an annular second sealing member is attached to a peripheral edge portion of the gas inlet.

11. The mass spectrometry device according to claim 10, further comprising a fixing member that fixes the second sealing member to the ion source by being screwed into the ion source,
wherein the fixing member includes a hollow shaft portion that is inserted into the second sealing member and screwed into the ion source, and an annular head portion that is provided at one end portion of the shaft portion and presses the second sealing member toward the ion source,
in a state where the ion source is not closed with respect to the main body, a thickness of the head portion is equal to or less than a thickness of the second sealing member, and
an abutting surface of the head portion with the second sealing member includes a tapered surface tapered toward the ion source.
